(19) United States
(12) Patent Application Publication
(10) Pub. No.: US 2024/0240665 A1
(43) Pub. Date: Jul. 18, 2024

(54) REVERSIBLE FASTENER CAP

(71) Applicant: SMART8, LLC, Bonaire, GA (US)

(72) Inventor: Douglas K. Omli, Bonaire, GA (US)

(21) Appl. No.: 18/505,381

(22) Filed: Nov. 9, 2023

Related U.S. Application Data
(60) Provisional application No. 63/479,828, filed on Jan. 13, 2023.

(51) Int. Cl. F16B 43/00

(52) U.S. Cl. CPC F16B 43/00; F16B 15/00

(57) ABSTRACT

A fastener cap includes a web with opposed top and bottom faces, the web bounded by a peripheral flange, wherein the peripheral flange includes: a planar top surface; and a planar bottom surface which is spaced away from and parallel to the planar top surface. A strip, includes a plurality of the fastener caps disposed in a linear array and joined by flexible tabs.

This invention relates generally to fasteners, and more particularly to fastener caps.

### BACKGROUND

Fastener caps are typically small disks used underneath the head of a fastener such as a nail or staple to spread out the fastener load and prevent pull-through and tear out of substrate materials.

Some fastener caps are manufactured with a fastener already inserted. These are typically used for hand installation using a hammer.

Other fastener caps are manufactured without a fastener already inserted. These are used in air powered tools or manual tools (e.g., staplers, nailers, or drivers) that store a supply of the fastener caps and a separate supply of fasteners. In use, the tool drives a fastener through one of the fastener caps into the substrate, securing both the fastener and the cap.

One problem with prior art fastener caps is that they typically have a dish-like shape which is not symmetrical top to bottom. When arranged for storage, typically by rolling onto a spool, they are not reversible. Because some tools invert the caps during the process of unloading them from a roll, this means that prior art fastener caps must be packaged for a particular branded tool and are not universally usable.

### BRIEF SUMMARY OF THE INVENTION

This problem is addressed by a fastener cap and a strip of fastener caps which are reversible.

According to one aspect of the technology described herein, a fastener cap includes a web with opposed top and bottom faces, the web bounded by a peripheral flange, wherein the peripheral flange includes: a planar top surface; and a planar bottom surface which is spaced away from and parallel to the planar top surface.

According to another aspect of the technology described herein, a strip of fastener caps includes a plurality of fastener caps disposed in a linear array and joined by flexible tabs, each fastener cap including: a web with opposed top and bottom faces respectively, bounded by a peripheral flange, wherein the peripheral flange includes: a planar top surface; and a planar bottom surface which is spaced away from and parallel to the planar top surface.

### BRIEF DESCRIPTION OF THE DRAWINGS

The invention may be best understood by reference to the following description taken in conjunction with the accompanying drawing figures in which:

FIG. 1 is a perspective view of an exemplary strip of fastener caps;

FIG. 2 is a top plan view of the strip of FIG. 1;

FIG. 3 is a bottom plan view of the strip of FIG. 1;

FIG. 4 is a left side elevation view of the strip of FIG. 1;

FIG. 5 is a right side elevation view of the strip of FIG. 1;

FIG. 6 is a front elevation view of the strip of FIG. 1;

FIG. 7 is a rear elevation view of the strip of FIG. 1;

FIG. 8 is a perspective view of a single fastener cap;

FIG. 9 is a top plan view of the fastener cap of FIG. 8;

FIG. 10 is a bottom plan view of the fastener cap of FIG. 8;

FIG. 11 is a left side elevation view of the fastener cap of FIG. 8;

FIG. 12 is a right side view of the fastener cap of FIG. 8;

FIG. 13 is a front elevation view of the fastener cap of FIG. 8;

FIG. 14 is a rear elevation view of the fastener cap of FIG. 8;

FIG. 15 is a sectioned perspective view of the fastener cap of FIG. 8;

FIG. 16 is a sectioned elevation view of the fastener cap of FIG. 8;

FIG. 17 is a sectioned elevation view of an alternative embodiment of a fastener cap;

FIG. 18 is a sectional view of a substrate having a fastener cap attached thereto with a staple; and

FIG. 19 is a sectional view of a substrate having a fastener cap attached thereto with a nail.

### DETAILED DESCRIPTION OF THE INVENTION

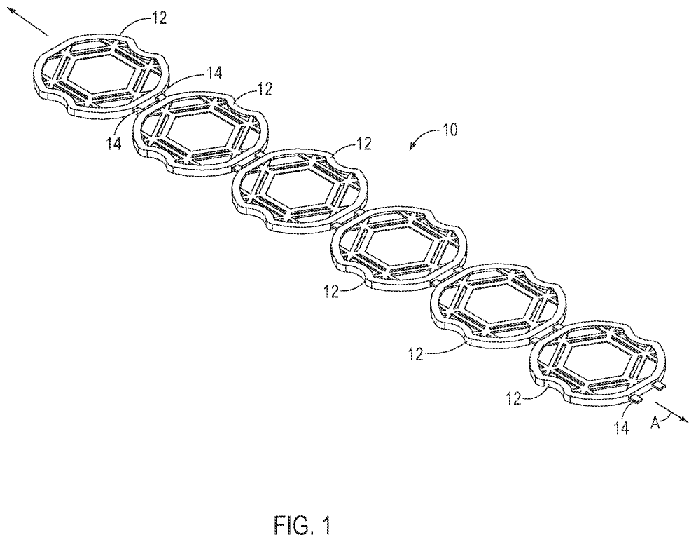

Referring to the drawings wherein identical reference numerals denote the same elements throughout the various views, FIGS. 1-5 depict an exemplary strip 10 comprising a plurality of fastener caps 12 disposed in a linear array and interconnected by tabs 14. The strip 10 extends along a main axis “A”.

The fastener caps 12 and the strip 10 may be constructed of any material having sufficient strength to resist anticipated fastener loads in use. Examples of suitable materials include plastics which are inexpensive, lightweight, easily formed, and environmentally resistant.

Specific examples of suitable plastics include polyethylene (“PE”) and polypropylene (“PP”).

The strip 10 (comprising the fastener caps 12 and the tabs 14) may be formed as one integral, unitary, or monolithic body. While any suitable manufacturing method may be used, the fastener caps 12 and strip 10 are especially suitable for molding processes such as injection molding.

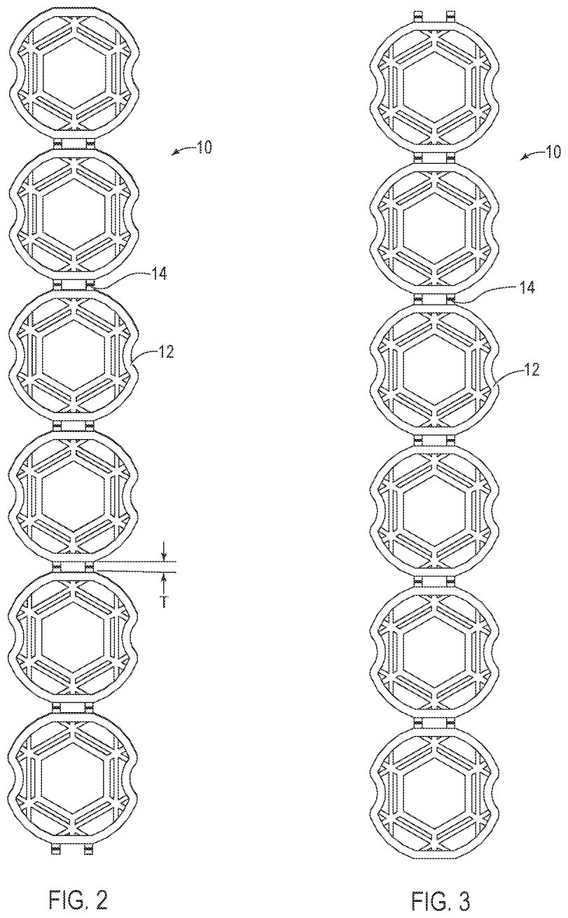

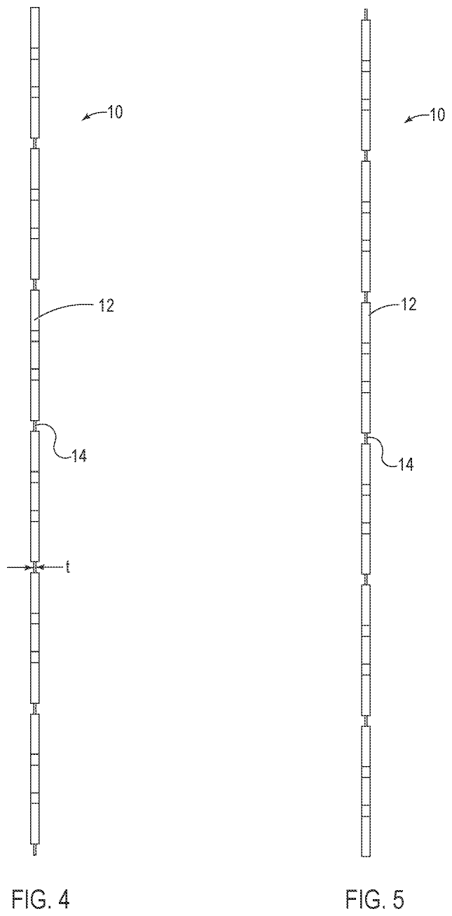

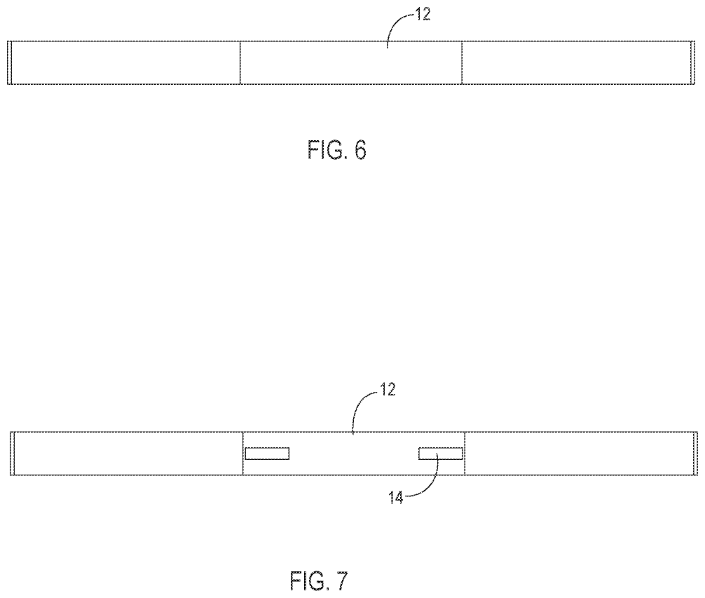

The tabs 14 are sized to provide adequate strength to hold the fastener caps 12 together, while permitting them to be rolled up for storage, and while being easily cut or broken apart to separate the fastener caps 12 during the installation process. In one example, the tabs 14 may have a length “T” of approximately 2 mm (FIG. 2), and a thickness “t” of approximately 0.4 mm (FIG. 4). In the illustrated example, a pair of spaced-apart tabs 14 extend between each adjacent pair of fastener caps 12.

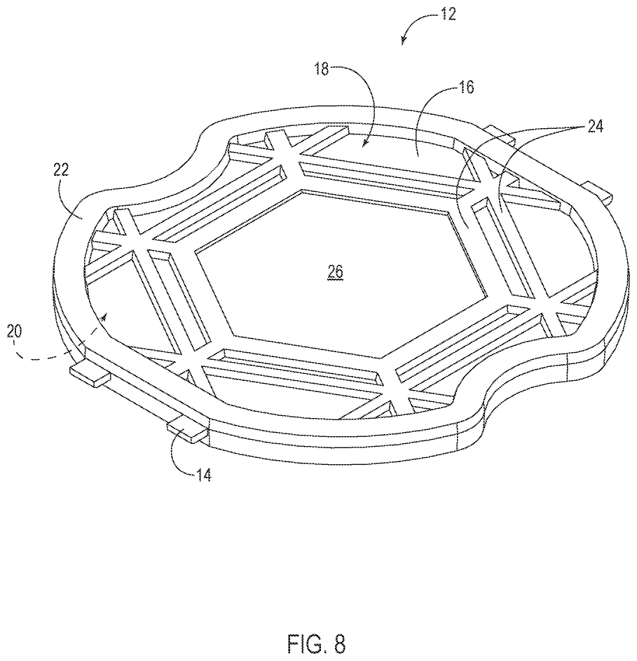

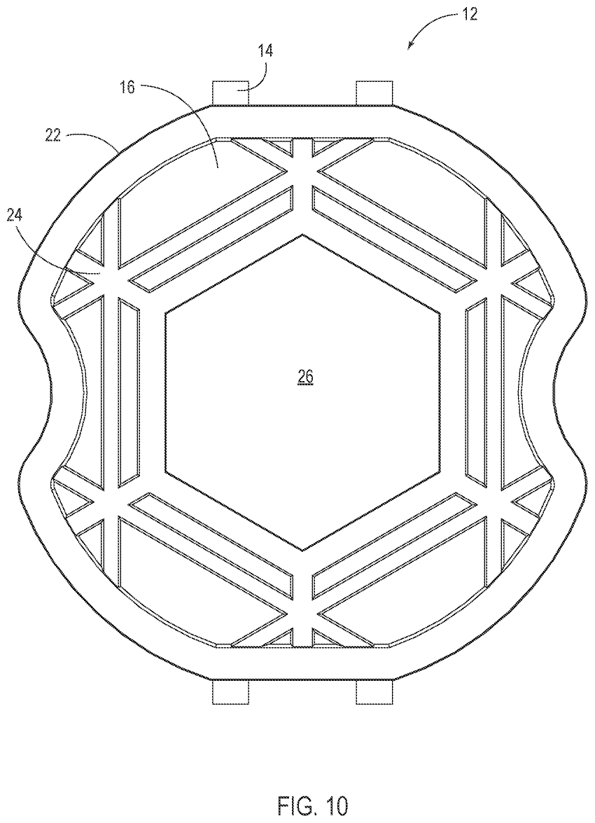

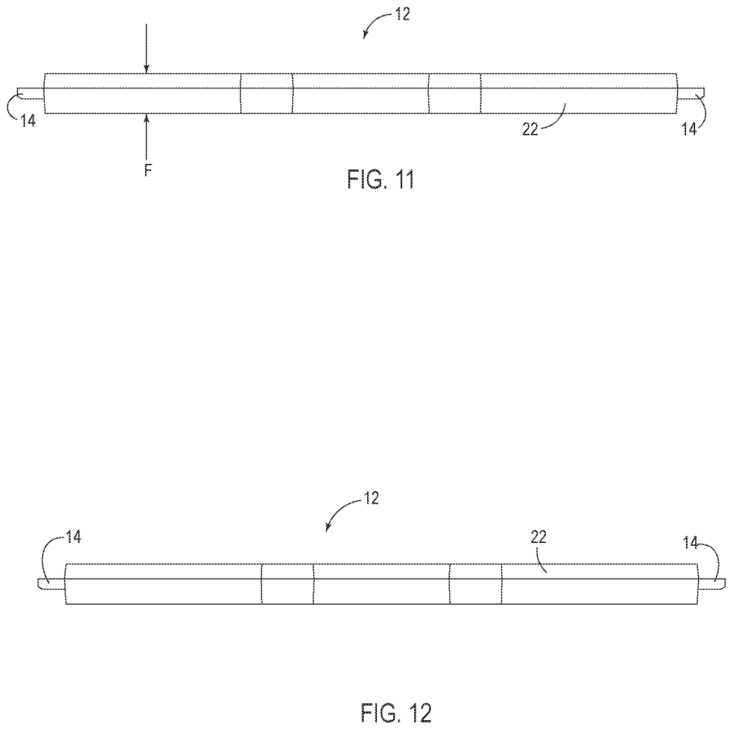

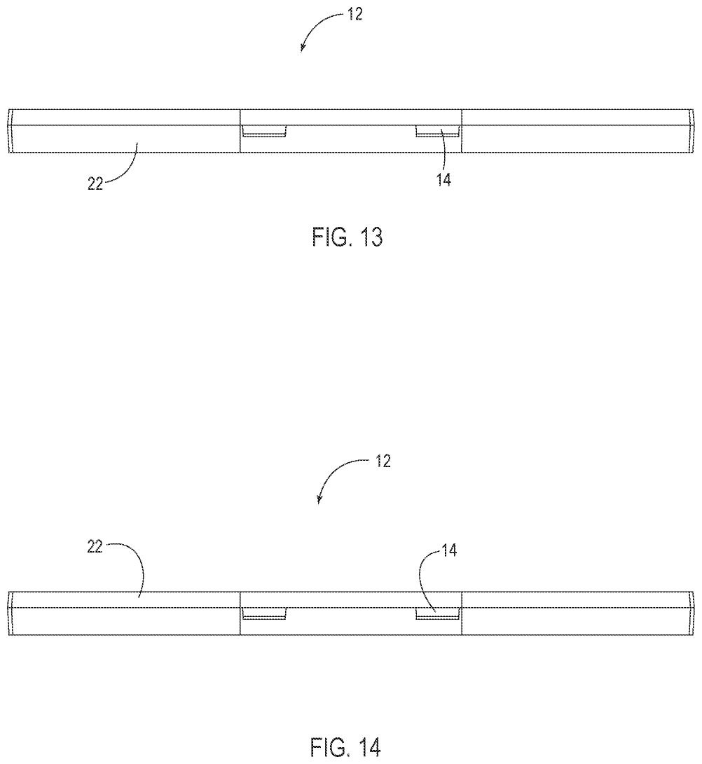

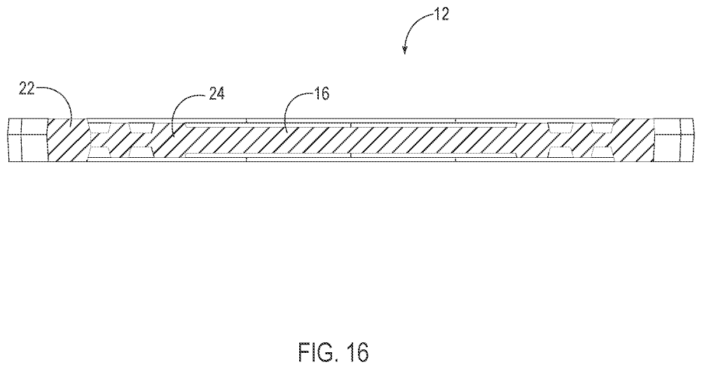

FIGS. 8-16 illustrate an individual one of the fastener caps 12 in more detail.

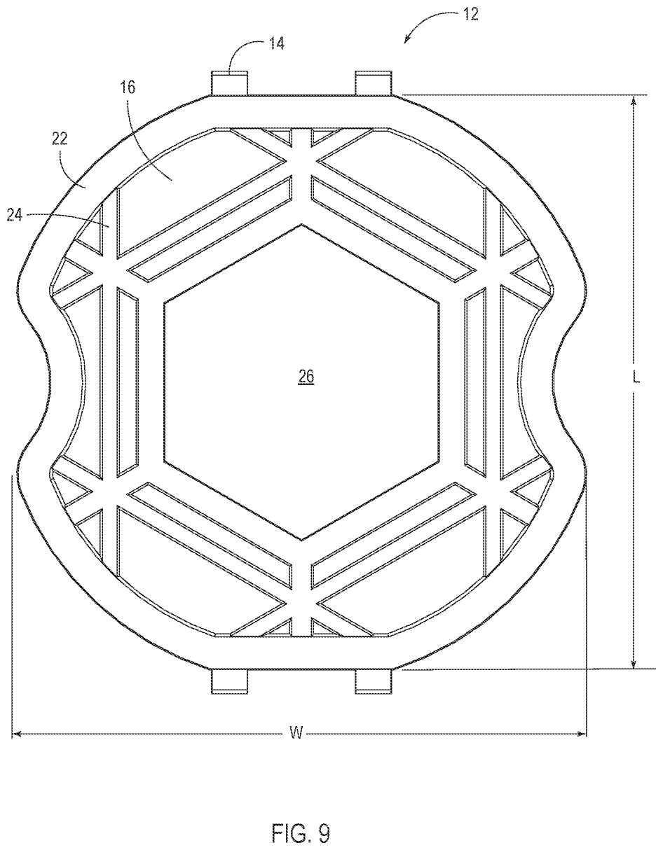

The fastener caps 12 have outside dimensions suitable for spreading the load of a fastener while providing a convenient size and shape for handling and installation. In one example, the fastener cap 12 has an overall length “L”, measured parallel to the strip axis A, of approximately 24 mm. In one example, the fastener cap 12 has an overall width “W”, measured perpendicular to the length L, of approximately 25 mm (see FIG. 9).

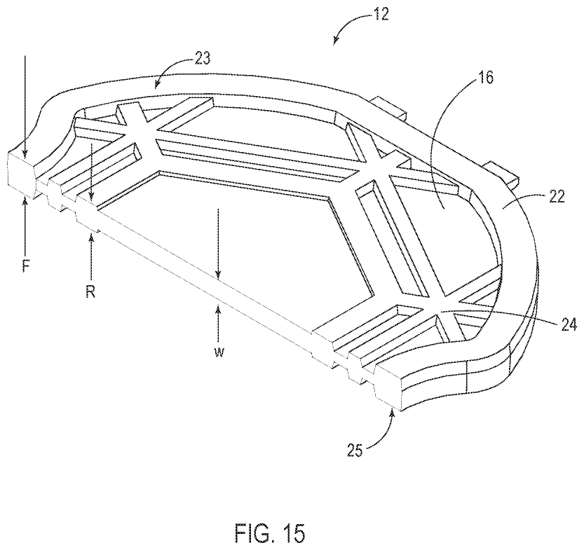

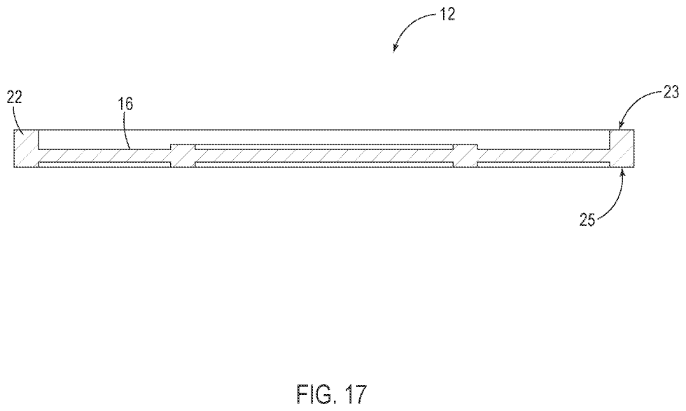

The fastener cap 12 may have a structure incorporating a variable thickness, and particularly may have a web 16 with opposed top and bottom faces 18, 20 respectively, bounded by a peripheral flange 22. The peripheral flange 22 has an overall thickness greater than the thickness of the web 16. In one example, the peripheral flange 22 may have a thickness approximately three times a thickness of the web 16. In order to provide reversibility, that is, top to bottom symmetry, the peripheral flange 22 may be configured with a planar top surface 23 and a planar bottom surface 25 that is spaced-apart from the top surface 23, wherein the top and bottom surfaces 23, 25 are parallel to each other (see FIG. 15). Furthermore, the top and bottom surfaces 23, 25 may define the furthest top and bottom extents of the fastener cap 12. In one embodiment, to provide complete top to bottom symmetry, the position of the web 16 may be in the middle of the thickness of the peripheral flange 22. Stated another way, the peripheral flange 22 may protrude an equal distance from each face of the web 16. Alternatively, as seen in FIG. 17, the position of the web 16 may be located other than in the middle of the thickness of the peripheral flange 22.

In one example, the peripheral flange 22 may have a thickness “F” of approximately 1.5 mm (thicknesses best seen in FIG. 15). Thickness F also represents the overall maximum thickness of the fastener cap 12.

In one example, the web 16 may have a thickness “w” of approximately 0.5 mm.

In addition to the peripheral flange 22, the fastener cap 12 may incorporate stiffening members such as ribs 24 protruding from the web 16. In order to provide reversibility, that is top to bottom symmetry, the web 16 may be positioned in the middle of the thickness of the ribs 24. Stated another way, the ribs 24 may protrude an equal distance from each face of the web 16.

In one example, the overall thickness “R” of the ribs 24 may be approximately 0.9 mm.

The ribs 24 may be arranged in any pattern which provides enhanced stiffness to the web 16. In the illustrated example, the ribs 24 are arranged in a pattern forming a hexagonal shape.

The ribs 24 may be arranged so as to leave a central area 26 of the web 16 clear for penetration of a fastener.

The strip 10 of connected fastener caps 12 may be folded or rolled into a convenient shape for storage and loading into a conventional driver tool (not shown). In use, the strip 10 is pulled out, and individual fastener caps 12 are detached from the strip 10 as fasteners are driven. Because the fastener caps 12 are reversible, a roll formed from the strip 10 is suitable for use in a driver tool without regard to the top-to-bottom orientation. Stated another way, the fastener caps 12 can be successfully installed whether they are unrolled directly from the roll, or they are inverted during or after the process of being unrolled.

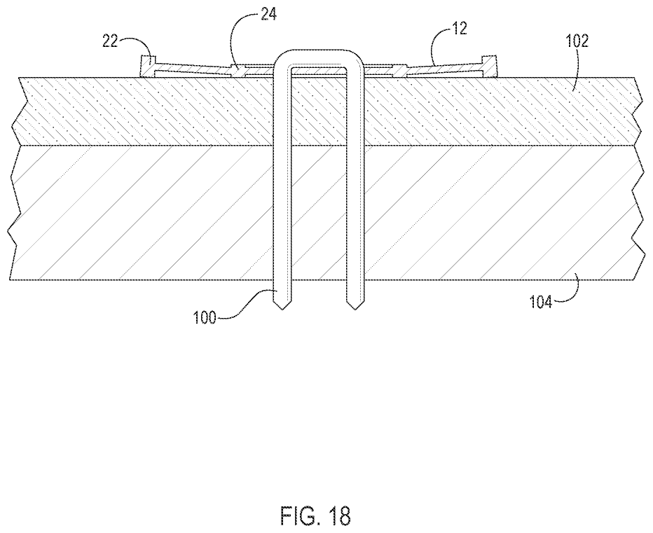

FIG. 18 shows the fastener cap 12 installed in a typical application, with a fastener 100 (e.g., a staple) driven through the fastener cap 12, a sheet of underlayment material 102, and a substrate 104.

The fastener cap 12 spreads out the point load of the fastener 100, preventing it from tearing through the shingle 102 and increasing the holding power of the fastener 100.

The peripheral flange 22 and ribs 24 of the fastener cap 12 give adequate strength and stiffness to avoid excessive buckling when driven in, while permitting the overall mass and therefore cost of the fastener 100 to be minimized.

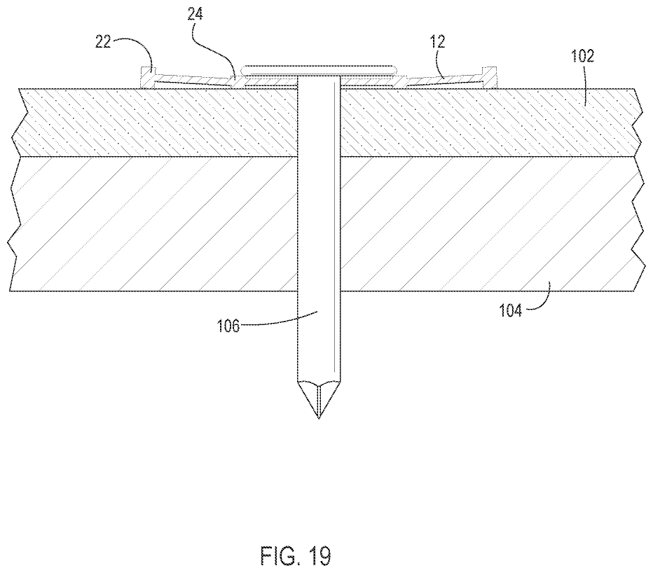

FIG. 19 shows an alternate application in which the fastener cap 12 is installed with a fastener 106 (e.g., a nail) driven through the fastener cap 12, a sheet of underlayment material 102, and a substrate 104. The function of the fastener cap 12 is the same as if installed with a staple.

The fastener cap described herein has advantages over prior art devices.

Specifically, it has the ability to be loaded in and fed from any type of prior art air powered driver tools or manual driver tools regardless of loading direction. It has no functional “top” or “bottom” that must be observed by the installer. Stated another way, it is equally suitable for use “right side up” or “upside down”.

The foregoing has described a fastener cap and a method for its use. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends, or to any novel one, or any novel combination, of the steps of any method or process so disclosed.

What is claimed is:

1. A fastener cap, comprising: a web with opposed top and bottom faces, the web bounded by a peripheral flange, wherein the peripheral flange includes:
a planar top surface; and
a planar bottom surface which is spaced away from and parallel to the planar top surface.

2. The fastener cap of claim 1, wherein:
a thickness of the peripheral flange is defined between the planar top surface and the planar bottom surface of the peripheral flange; and
the web is positioned in the middle of the thickness of the peripheral flange.

3. The fastener cap of claim 1, further comprising one or more ribs protruding from the web.

4. The fastener cap of claim 3, wherein the one or more ribs protrude an equal distance from each of the faces of the web.

5. The fastener cap of claim 3, wherein the one or more ribs are arranged in a pattern forming a hexagonal shape.

6. The fastener cap of claim 3, wherein the one or more ribs are positioned so as to leave a central area of the web clear for penetration of a fastener.

7. The fastener cap of claim 1, wherein the cap is constructed of plastic.

8. The fastener cap of claim 1, wherein the cap is constructed of polyethylene.

9. The fastener cap of claim 1, wherein the cap is constructed of polypropylene.

10. A strip, comprising a plurality of the fastener caps of claim 1 disposed in a linear array and joined by flexible tabs.

11. A strip of fastener caps, comprising a plurality of fastener caps disposed in a linear array and joined by flexible tabs, each fastener cap including:
a web with opposed top and bottom faces, bounded by a peripheral flange, wherein the peripheral flange includes:
a planar top surface; and
a planar bottom surface which is spaced away from and parallel to the planar top surface.

12. The strip of fastener caps of claim 11, wherein:
a thickness of the peripheral flange is defined between the planar top surface and the planar bottom surface of the peripheral flange; and
the web is positioned in the middle of the thickness of the peripheral flange.

13. The strip of fastener caps of claim 11, wherein each of the fastener caps includes one or more ribs protruding from the web thereof.

14. The strip of fastener caps of claim 13, wherein the one or more ribs protrude an equal distance from each of the faces of the web.

15. The strip of fastener caps of claim 11, wherein the fastener caps and the tabs are constructed of plastic.

16. The strip of fastener caps of claim 11, wherein the fastener caps and the tabs are constructed of polyethylene.

17. The strip of fastener caps of claim 11, wherein the fastener caps and the tabs are constructed of polypropylene.

18. The strip of fastener caps of claim 11, wherein the fastener caps and the tabs are one unitary body.

19. The strip of fastener caps of claim 11, wherein a pair of the tabs extend between each adjacent pair of the fastener caps.
